(19) United States
(12) Patent Application Publication
(10) Pub. No.: US 2009/0097794 A1
(43) Pub. Date: Apr. 16, 2009

(54) Gear Bearing

(76) Inventor: Darrell Grayson Higgins, Trinity, NC (US)

Correspondence Address: ROBERT W PITTS, PO BOX 11483, WINSTON-SALEM, NC, 27116-1483, US

(21) Appl. No.: 12/083,206

(22) PCT Filed: Mar. 24, 2006
(86) PCT No.: PCT/US2006/010782

§ 371 Date: Sep. 8, 2008

(51) Int. Cl. F16C 33/36

(52) U.S. Cl. 384/565

(57) ABSTRACT

Gear bearings 1, 20, 30, 40, 50, 60, 70, 80, 90A and 90B, and 100 include gear, such as 9, and opposite facing tapered load bearing surfaces, such as 13 and 14. These gear bearings are positioned between, such as raceways 6 and 7 or 18 and 19, with bearing gears, such as 9 and 22, meshing with raceway gears, such as 10 and 21. The tapered surfaces preferably comprise the primary load bearing surfaces, with a line contact being maintained between the gear bearings and the raceways. The gears maintain proper registration of the gear bearings to prevent gathering. The same gear bearings can be employed in either linear bearing assemblies or rotary bearing assemblies. The gear bearings can be used in applications in which the defined position of the gear bearings can be used for control and monitoring moving parts or components, and the gear bearings can be used in devices, which transmit mechanical force.

### BACKGROUND OF THE INVENTION

1. Field of the Invention

This invention relates to bearings for use between movable components parts including parts between which there if relative linear movement and parts between which there is relative rotational movement. These bearings can be employed as guide bearings, thrust bearings and rotary bearings, such as journal bearings. More particularly, these bearings include gears, which mesh with geared raceways to properly position the bearings and to prevent bearings from gathering.

2. Description of the Prior Art

Conventional bearings providing sliding contact between surfaces can be divided into three classes. Radial or rotary bearings support rotating shafts or journals. Thrust bearings support axial loads on rotating members. Guide, slipper or linear bearings guide moving parts in a straight line. Bearings, which operate without lubrication between moving surfaces, are typically formed of nylon of Teflon. For hydrodynamic bearings, a wedge or film of lubricating material produces either whole or partial separation of the bearing surfaces. If the lubrication is introduced under pressure to separate mating surfaces even in the presence of an applied load are referred to as hydrostatic bearings.

Rolling contact bearings substitute a rolling element, such as a ball or roller, and are commonly referred to as antifriction bearings. These bearings are normally made with hardened rolling elements and races, and they usually employ a separator to space the rolling elements and reduce friction. A common antifriction bearing employs a deep-groove ball bearing with ribbon-type separator and sealed-grease lubrication used to support a shaft with radial and thrust loads in rotation equipment. Rolling contact bearings, such as balls and rollers are normally held to diametrical tolerances of 0.001 inch or less.

Rolling contact bearings will gather if some means is not provided to keep the rolling elements, such as balls or cylindrical rollers apart. If the rolling contact bearings gather, additional friction and heat result and the life of the rolling contact elements will be reduced. Therefore raceways, cages or separators can be provided to maintain the separation between rolling contact bearings and prevent the bearings from gathering. These raceways or cages can be either expensive to manufacture and assembly or if less expensive will not provide adequate life or performance. Since conventional roller, ball and thrust bearings are fabricated as simple shapes, maintaining the separation between adjacent bearings is entirely dependent upon the shape of the raceway, cage or separator.

U.S. Pat. No. 3,998,506 discloses a configuration in which protruding or recessed members are provided on the bearing and on raceways in an attempt to prevent the bearings from gathering. In the bearings depicted therein the bearings rotate in a direction generally transverse to the axis of rotation of the rotating parts with which they are employed. Even where conical bearings are employed side loads in only one direction is provided. Furthermore movement of these bearings is still primarily due to the contact between smooth load bearing surfaces. The instant invention differs from the bearing assemblies therein in that gears are provided for maintaining proper registration and alignment of the bearings relative to the raceways and the bearings of the instant invention are adapted to bear side loads applied in any direction relative to the direction of linear or rotational movement of the moving parts or components.

### SUMMARY OF THE INVENTION

A bearing according to this invention is suitable for supporting a first part moving relative to a first part in the presence of side loads acting between the two moving parts directed in either two directions perpendicular to a path defining the relative movement of the first and second moving parts. This bearing is suitable for use in either rotary bearing assemblies or guide bearing assemblies. The bearing includes two tapered load bearing surfaces oriented such that contact lines formed along the first and second tapered load bearing surfaces intersect a plane parallel to the path of relative movement at an acute angle, whether that path is linear or circular. A radial gear can extend between the first and second tapered load bearing surfaces. The first and second tapered load bearing surfaces extend away from the radial gear. The radial gear imparts rotation to the bearing to reduce sliding engagement with the first and second load bearing surfaces when relative movement of the two moving parts is in either a linear path or a rotary path. The first tapered load bearing surface bears side loads in a first direction perpendicular to the path of relative movement and the second tapered load bearing surface bears side loads in a second direction, opposite the first direction.

The invention also presents a rotary bearing assembly comprising inner and outer circular raceways and a plurality of gear bearings disposed between the inner and outer circular raceways. The plurality of gear bearings and the inner and outer raceways have a common axis of rotation. The inner and outer raceways each include at least one raceway tapered load bearing surface disposed at an angle relative to the common axis of rotation. At least one of the inner and outer raceways has a first gear profile with a gear axis aligned with the common axis of rotation. Each gear bearing includes a second gear profile matable with the first gear profile on at least one of the raceways, and a gear bearing tapered surface opposed to one tapered load bearing surface of one of the inner and outer raceways, so that the gear profiles on the gear bearing and n at least one of the inner and outer raceways mesh while loads are borne by the tapered load bearing surfaces on the gear bearing and on at least one of the inner and outer raceways.

### BRIEF DESCRIPTION OF THE DRAWINGS

FIG. 1 is a view showing a version of linear motion that employs gear bearings and its associated raceways. Also shown is a cut-away view of a gear bearing, in which its gear teeth are meshed with the raceway's teeth.

FIG. 2 is a view showing one configuration of a gear bearing that is diamond shaped and has gear teeth employed around its center. Also shown are arrows that show forces of load capabilities impacting the gear bearing.

FIG. 3 shows an end-view of the linear motion bearing of FIG. 1.

FIG. 4 is a view showing a version of rotary motion that employs gear bearings and its associated raceways. Also shown is a cut-away view of the gear bearing, in which its gear teeth are meshed with the inner raceway's teeth, and that same gear bearing employs a signaling device.

FIG. 5 shows an end-view of the rotary gear bearing of FIG. 4.

FIG. 6 is a view showing another configuration of a gear bearing that is hour-glass shaped and has gear teeth employed around its center. Also shown are arrows that show forces of load capabilities impacting the gear bearing.

FIG. 7 is a view showing another configuration of gear bearing that is diamond shaped and has gear teeth employed at both ends. Also shown are arrows that show forces of load capabilities impacting the gear bearing.

FIG. 8 is a view showing another configuration of a gear bearing that is hour-glass shaped and has gear teeth employed at both ends. Also shown are arrows that show forces of load capabilities impacting the gear bearing.

FIG. 9 is a view of a simple gear bearing that can be easily molded using straight pull mold tooling.

FIG. 10 is a view of a more complicated version of a one piece molded gear bearing that can also be molded using straight pull mold tooling.

FIGS. 11A and 11B are views of a two piece molded gear bearing.

FIG. 12 is a view showing the rotary gear bearing used as a journal bearing.

FIG. 13 is a sectional view showing one version of a journal gear bearing such as seen in FIG. 12.

FIG. 14 is a view of another version of a rotary journal gear bearing assembly.

FIG. 15 is a view of a transfer mechanism that can employ smart gear bearings.

FIG. 16 shows the manner in which smart gear bearings of the type shown in FIG. 15 can be employed in a warehouse or inventory control system.

FIG. 17 shows a transmission that can employ gear bearings to transmit power.

FIGS. 18A-D shows a bevel gear bearing mechanism.

### DETAILED DESCRIPTION OF THE PREFERRED EMBODIMENTS

The gear bearing according to this invention provides support for two mechanical parts or components moving relative to each other. This gear bearing will bear side loads between the moving parts in at least one direction perpendicular to the direction of movement. In most embodiments side loads applied in any direction transverse to the direction of movement will be borne by this gear bearing. This gear bearing can be employed as a rotary bearing, serving either as a radial bearing or a thrust bearing or it can be employed as a guide or linear bearing. When employed as a rotary bearing, the gear bearing is used with cylindrical raceways, and when employed as a guide bearing, the gear bearing is employed with linear raceways. When employed as a rotary bearing, the preferred embodiments of this gear bearing will support the moving parts in response to radial side loads or forces applied perpendicular to the axis of rotation of a moving part or shaft and in response to side loads applied parallel to the axis of rotation. When employed as a linear bearing, components of side loads or forces applied about two axes orthogonal to the path of the moving parts will be borne by this gear bearing. In some applications, the gear bearing is suitable for use as a fluid film bearing and it can function as a hydrostatic or hydrodynamic bearing or the bearing can be lubricated by grease or other lubricants. In less stressful applications, versions of this gear bearing can be employed without a lubricating film or grease.

The preferred embodiments of the gear bearings include two tapered surfaces and a gear, which will normally be located between the two tapered surfaces. In some embodiments, the gear can be located at one end of the bearing and, although desirable, it is not always essential that the gear be located between the two tapered surfaces. In most applications, the tapered surfaces would be in the form of truncated conical surfaces, although truncation of these conical surfaces is related more to manufacturing considerations than to the operational efficacy of the gear bearing. The gear will typically be a spur gear with the axis of rotation of the spur gear being coincident with the axis of rotation of the conical or tapered surfaces. In the principal embodiments, the tapered or conical surfaces comprise the principal load bearing surfaces against which most of the side loads will be applied. The gear on the gear bearing serves primarily to impart a predetermined angular velocity to the gear bearing, so that its absolute position and the position of any single gear bearing relative to other gear bearings can always be known. In most applications the gear on the gear bearing engages a complementary gear on the raceway. In this way multiple gear bearings mounted on the same raceway will not tend to gather. In other applications, especially in certain configurations employing a linear bearing assembly, the gear bearings may be allowed to gather in a prescribe manner. However, spacing between bearings is important, and this mechanism insures that adjacent gears will remain properly spaced. By employing gear bearings in accordance with this invention, it will not be necessary to employ a separate cage, as commonly employed with standard bearings.

A gear bearing assembly will include gear bearings and raceways relative to which the gear bearings move. In normal applications multiple gear bearings are employed between an inner and an outer raceway, with mutual movement occurring between the inner and outer raceways.

The raceways employed with gear bearings include a complementary raceway gear and smooth complementary raceway load bearing surfaces, which will be disposed opposite to the tapered surfaces on the gear bearings. For a rotary bearing, the raceway load bearing surfaces will be in the form of cylindrical surfaces, which are tapered relative to the axis of rotation of the raceways. For a linear or guide bearing the load bearing raceway surfaces would be linear as would the raceway gear, which could also be considered to be a rack. The raceway gear, for both rotary and linear applications, is positioned to engage the gear on the gear bearing, and if spur gears are employed on the gear bearing, complementary spur gears would normally be employed on the raceway. In some instances, a spur gear on one of the two gear bearing assembly components, could be employed with a series of holes aligned to mesh with the gears on the other component. Alternatively, the gear surface on one of the two meshing components could be formed by cutting teeth into the surrounding material. Any number of standard gear configurations could be employed to form the gear profiles on both parts, so long as the gears on one component mesh with the gears on the other component of the gear bearing assembly.

The dimensions of the gear bearing tapered load bearing surfaces and gears in relation to the smooth raceway load bearing surfaces and the raceway gears are preferably chosen so that most of the side loads are borne where the tapered surfaces engage complementary surfaces on the raceways. Preferably a spacing of 0.001 inch is maintained between these primary load bearing surfaces. Oil, grease or someother lubricant is preferably dispersed between these surfaces. It is preferred that only small side loads be applied directly to the gears so as not to produce wear on the meshing gears. It should be understood, however, that the relative dimensions of the gears and the tapered, inclined or conical surfaces can be altered to account for specific applications. The inclination of the tapered, inclined or conical surfaces can be varied depending upon the anticipated relative magnitude of side loads perpendicular to or parallel to the axis of rotation of the gear bearing. Furthermore the width or thickness of the gears can be varied according to the requirements of a specific design application. Although it is preferable for side loads to be transferred directly between the primary load bearing surfaces, it should be understood that some loads could be transferred through the gears to the primary load bearing surfaces. There may even be applications in which most of the loads can be transferred through the gears to the inclined load bearing surfaces without departing from the basics of this invention, although it is currently believed that this is not the preferred approach.

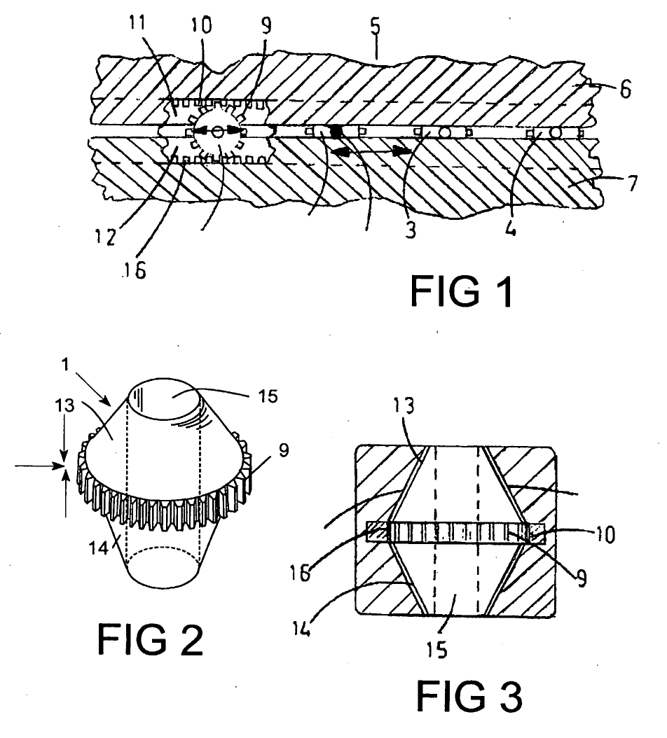

A first embodiment of a gear bearing is shown in FIG. 2 and the use, of this gear bearing 1 in a linear or guide gear bearing assembly is shown in FIG. 1. According to this invention the gear bearing 1 includes gear teeth 9 and primary load bearing surfaces 13 and 14. The bearing can be solid or with a hole 15, which may be employed for manufacturing purposes, such as to position the stock in a CNC machine for machining.

The preferred embodiment of linear-motion bearing assembly 5 shows gear bearing teeth 9 meshed with gear teeth 10 on a first linear raceway 6 and gear teeth 16 on a second raceway 7. As raceway 7 reciprocates, gear bearing 1 travels back and forth always returning it to its original position. The teeth on four gear bearings 1, 2, 3 mesh with the gear teeth 10 and 16 on raceways 6. In this and in other embodiments, the gear teeth on both the gear bearing and the raceway can protrude so that spur gears on each component will mesh, or the gears on either the gear bearing or the raceway can be recessed, by removing material from the material employed to fabricate the gears. The recessed gear profile can also be in the form or slots positioned in registry with the protruding gears on the other component. The primary load bearing surfaces 13 and 14 on gear bearing 1 engage load bearing surfaces 11 and 12 of raceways 6 and 7. In this embodiment, the load bearing surfaces 13 and 14 are tapered, and preferably are smooth conical surfaces, which extend from the top and bottom of the gear bearing teeth 9 and are truncated at the upper and lower ends of the gear bearing 1. The load bearing surfaces 13 and 14 extend at an acute angle relative to the path of movement of the moving parts. For the linear gear bearing assembly 5, the tapered load bearing surfaces 11 and 12 are inclined relative to the axis of rotation of the gear bearings 1, 2, 3 and 4 and each raceway load bearing surface comprises a substantially flat surface. The angle of inclination of the raceway load bearing surfaces 11 and 12 is the same as the angle of inclination of the primary load bearing surfaces 13 and 14 on the gear bearings 1, 2, 3, 4, as shown in the section view of FIG. 3. As the moving part or components on which raceways 6 and 7 are mounted reciprocate relative to each other, the conical load bearing surfaces 13 and 14 on the gear bearings 1, 2, 3, 4 rotate along the flat raceway load bearing surfaces 11 and 12. The gear bearing gear teeth 9 also mesh with the gear teeth 10 and 16 on raceways 6 and 7 to insure that the spacing between gear bearings 1, 2, 3 and 4 remain constant and the gear bearings do not gather. This will prevent the sliding friction which would occur with conventional bearings, and the meshed gears on the gear bearings and the raceways will also prevent or at least significantly reduce any tendency of the primary load bearing surfaces on the gear bearings to slide relative to the tapered load bearing surfaces on the raceways 6 and 7. The tapered or conical load bearing surfaces 13 and 14 are located above and below the gear teeth 9 so that side loads parallel to the axis of rotation of the gear bearing and perpendicular to this axis of rotation will be borne by the gear bearings. Therefore any side load transverse to the direction of movement of the movable parts to which the raceways 6 and 7 are attached will be borne by the gear bearings and will primarily be borne by the gear bearing tapered surfaces 13 and 15 and the raceway load bearing surfaces 13 and 14. A line contact, not a point contact, will be established between the gear bearing load bearing surfaces and the raceway load bearing surfaces.

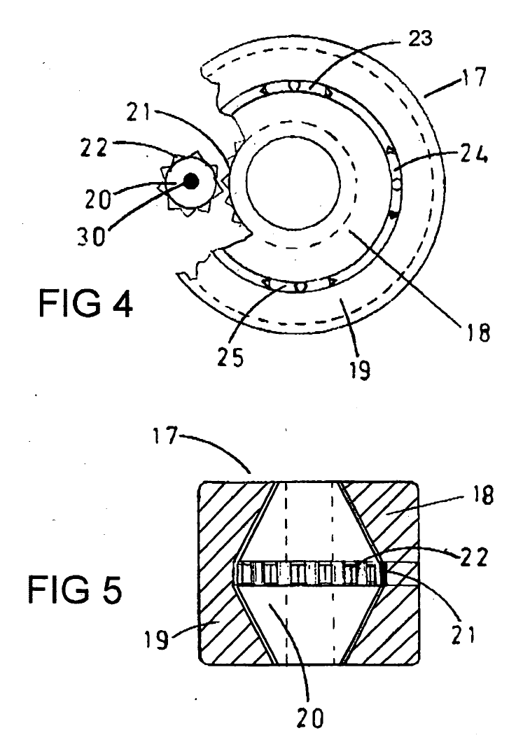

A rotary bearing gear bearing assembly 17, as shown in FIG. 4, can employ a gear bearing 20, which may be identical to the gear bearing 1, which is used for a linear or guide bearing. Gear bearing assembly 17 also includes an inner raceway 18 that employs gear teeth 21 around its circumference. These gear teeth 22 mesh with gear teeth 22 of gear bearing 20. Rotation of the inner raceway 18 thus causes the gear bearing 20, as well as other gear bearings 23, 24 and 25 to also rotate about their own axes of rotation, which are parallel to the axis of rotation of the inner raceway 18. The outer raceway 19 also includes gear teeth (not shown), which mesh with the gear teeth on the gear bearings 20, 23, 24 and 25. The pitch of the gear teeth on the outer raceway 19 will be the same as the pitch on the gear teeth 22 on the gear bearings 20, 23, 24 and 25, since the gear bearing teeth 22 must mesh with teeth on both raceways. Because the circumference on the outer raceway is greater than the circumference of the inner raceway, there will be more gear teeth on the outer raceway than on the inner raceway. It also follows that the circumference of both raceways on which gear teeth are located must be an integral multiple of the pitch of the teeth 22 on the gear bearing 20. Assuming that the outer raceway 19 is stationary, and is attached to a stationary member, the gear bearings 20, 23, 24 and 25 will traverse a circular path between the two raceways 18 and 19 and will move relative to each raceway and relative to the stationary component to which the outer raceway is attached. Although the gear bearings 20, 23, 24, and 25 will orbit the inner raceway 18, the spacing between the separate gear bearings 20, 23, 24, 25 will remain the same and the gear bearings will not tend to gather, since the gear bearing gear teeth 22 on all gear bearings will advance by the same amount relative to the inner raceway, and relative to the outer raceway.

Gear bearing 20 also includes tapered or conical load bearing surfaces 26 and 26 facing opposite directions above and below the gears 22, as shown in FIG. 5. The raceways 18 and 19 also have tapered load bearing surfaces 28 and 29. The degree of taper is the same on these surfaces so that primary load bearing surfaces can be closely spaced. Preferably, the load bearing surfaces 26 and 27 will be separated from the load bearing surfaces 28 and 29 by a thin lubricating film or grease.

As shown in FIG. 5, a cross sectional view through the rotary gear bearing assembly 17 is substantially the same as a cross section through the linear gear bearing assembly as shown in FIG. 3, indicating that the same gear bearing can be used in either application, provided of course that the pitch of the gear teeth is the same on each embodiment. Although the gear bearings 1 and 20 can be identical, it should be understood that other embodiments could employ the same basic method of operation as gear bearings 1 and 20, but could have a different shape.

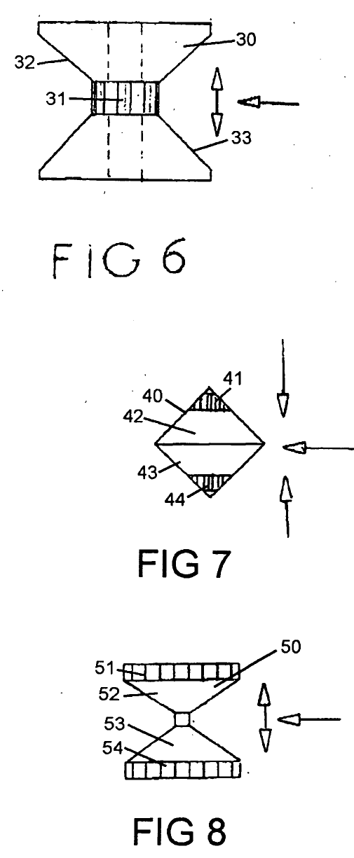

FIGS. 6-10 show alternate embodiments of gear bearings according to this invention. FIG. 6 shows an inverted cone or hour glass configuration of a gear bearing 30 in which a centrally positioned gear 31 is flanked by tapered load bearing surfaces 32 and 33. In this inverted cone configuration, the primary load bearing surfaces 32 and 33 face toward each other rather than away from each other as with the load bearing surfaces 13 and 14 as seen in FIG. 2. Gear bearing 30 is employed with raceways in which the raceway load bearing surfaces would then face away from each other and would be directly opposed to gear bearing load bearing surfaces 32 and 32. Gear bearing 30 thus represents the converse of the gear bearings 1 and 20, shown in FIGS. 2 and 5.

FIG. 7 is a view of another embodiment of a gear bearing 40 in which the primary load bearing surfaces 42 and 43 extend away from each other, and in which two gear profiles 41 and 44 are located on opposite ends of the load bearing. The embodiment of FIG. 7 is similar to the embodiment of FIGS. 2 and 5, and would operate with raceways having correspondingly positioned raceway gears. FIG. 8 is a still further embodiment of a gear bearing 50 that is similar to the embodiment of FIG. 6, but employs two gears 51 and 54 located at opposite ends of the primary load bearing surfaces 52 and 53. This version of the gear bearing may be easier to fabricate than the embodiment of FIG. 6 because the gear profiles 51 and 54 are more accessible and possibly easier to fabricate.

The gear bearing embodiments of FIGS. 2 and 5-8 can be machined from a metal stock. For instance the gears and the load bearing surfaces may be machined for bar or tubular stock using conventional CNC machines in which the conical load bearing surfaces are formed by a cutting tool engaging the spinning stock. The gears can be formed on a CNC machine using a turning center to cut the gears. The configurations of FIGS. 2, 5 and 8 would be easier to fabricate because the portion of the metal stock on which the gear profiles are to be formed are more accessible.

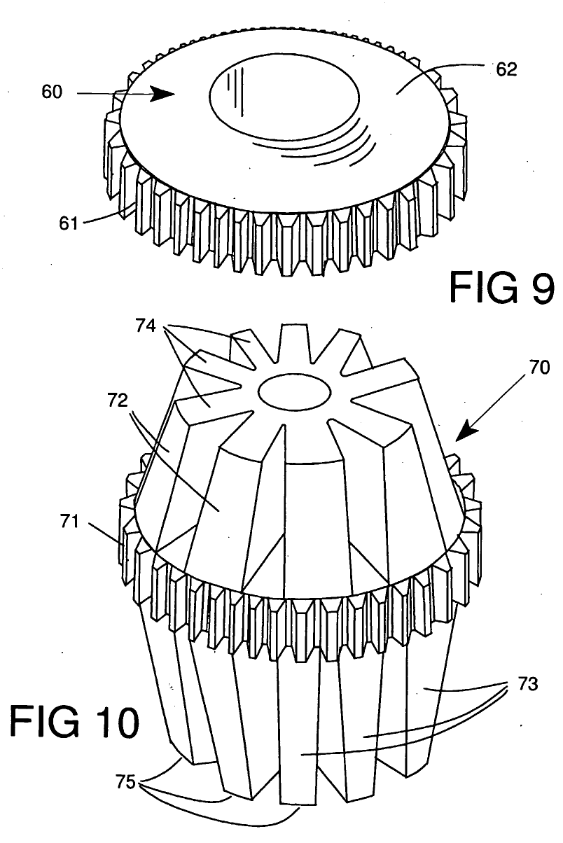

Molded gear bearings having substantially the same configuration as shown in the machined embodiments of FIGS. 2 and 5-8. Molded gear bearings may be especially suitable for applications in which the side loads on the load bearings are not a significant as in applications requiring a hardened machined steel gear bearing. A gear bearing, such as that shown in FIG. 9 could be molded using straight pull tooling in which the parting line is adjacent the center of the gear bearing so that the gear teeth are formed by mold tooling that is withdrawn parallel to the axis of rotation of the gear bearing. This load primary load bearing surface 62, and a lower primary load bearing surface hidden in this view, on this gear bearing 60 are tapered at a shallow angle relative to the plane of the gears 61. This gear bearing is therefore relatively thin and its thickness is not large compared to the diameter of the gears 61. Therefore any shrinkage as the molding resin shrinks as it cools may not result in serious problems. This gear bearing 60 would primarily be employed in configurations in which the predominate side loads would be parallel to the axis of rotation of the gear bearing. Side loads applied perpendicular to this axis or rotation would not be as effectively borne because of the relatively shallow angle of the primary tapered or conical load bearing surfaces.

The gear bearing 70 shown in FIG. 10 is more complex, primarily because of molding considerations. In this configuration, the angle of inclination of the primary load bearing surfaces 72 and 73 are steeper and this gear bearing is more suited for applications in which significant side loads perpendicular to the axis of rotation of the gear bearing will be encountered. Here the thickness of the gear bearing 70 between the top and bottom ends of the truncated conical load bearing surfaces 72 and 73 may be large enough so that shrinkage may be a problem as the molding resin solidifies. Irregular sink marks might then be a problem or the molded gear bearing must remain in the mold for an unacceptable time. The approach to this problem shown in FIG. 10 is to employ relatively thin fins 74 and 75 to form the primary load bearing surfaces 72 and 73. The side edges of these fins 74 and 75 would form discontinuous portions of the tapered or conical surfaces as shown in FIGS. 2 and 5, but there would be gaps between the fins 74 and 75. As long as these gaps are not too large, this configuration should still provide adequate load bearing surfaces, which will engage smooth tapered or conical load bearing surfaces on the corresponding raceways. For applications in which extreme side loads are applied, this configuration may not be suitable, but for other applications it may represent an acceptable compromise between performance and cost. This one piece molded gear bearing 70 does, in any case, demonstrate that the primary tapered or conical load bearing surfaces of this invention need not necessarily be smooth and continuous.

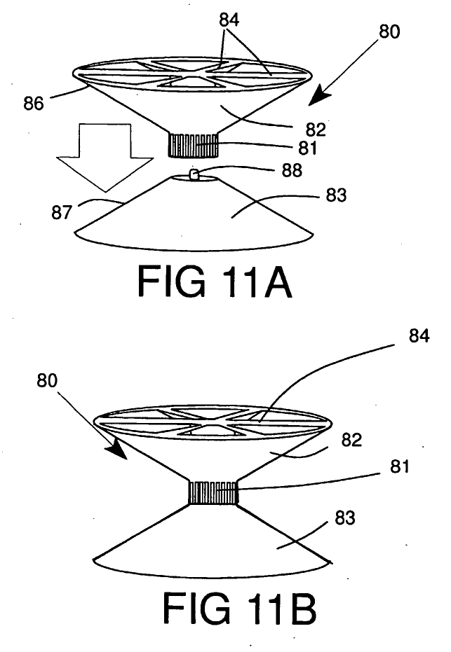

FIGS. 11A and 11B show another approach to molding a gear bearing in which the thickness would be a problem if thinner walls were not used. In this configuration, an inverted cone gear bearing 80 is fabricated by molding two separate components 86 and 87, which are mated to form the gear bearing 80 suitable for bearing sides loads in any direction perpendicular to the axis of rotation of the gear bearing. The upper portion 86 includes a smooth tapered or conical gear bearing surface 82. The interior of the cored upper gear bearing portion 86 has a plurality of strengthening ribs 84, which permit move even and more rapid cooling of the molded component. Gears 81 are formed on the lower end of the upper gear bearing portion 86, and this portion of the gear bearing 80 can be fabricated using straight pull molding tooling because there are not undercuts. The gear profile for this configuration could also be formed by molding slots instead of protruding gears 81, and these slots could receive protruding gears on the raceway. The lower gear bearing portion 87 would also be internally cored and would also have strengthening ribs, similar to ribs 84 but not visible in this view. To form a gear bearing having opposed primary load bearing surfaces 82 an 83, the two parts 86 and 87 must be joined together. A nib 88 representing a protruding member that can be received in a corresponding hole, not shown, on the lower surface of the upper gear bearing part 86, could be used as one mechanism to join the two parts together. Upper part 86 could be ultrasonically bonded to lower part 87 or other conventional means could be employed to bond the two parts together. Although the gear bearing 80 comprises an inverted cone gear bearing, it should be understood that the same approach could be employed to fabricate a two piece gear bearing having the oppositely facing cone configuration of FIGS. 2, 5 and 9. In some applications the upper cone section 86 could be employed as a stand alone item. In those situations the gear bearing would bear only side loads directed perpendicular to the axis of rotation of the gear bearing.

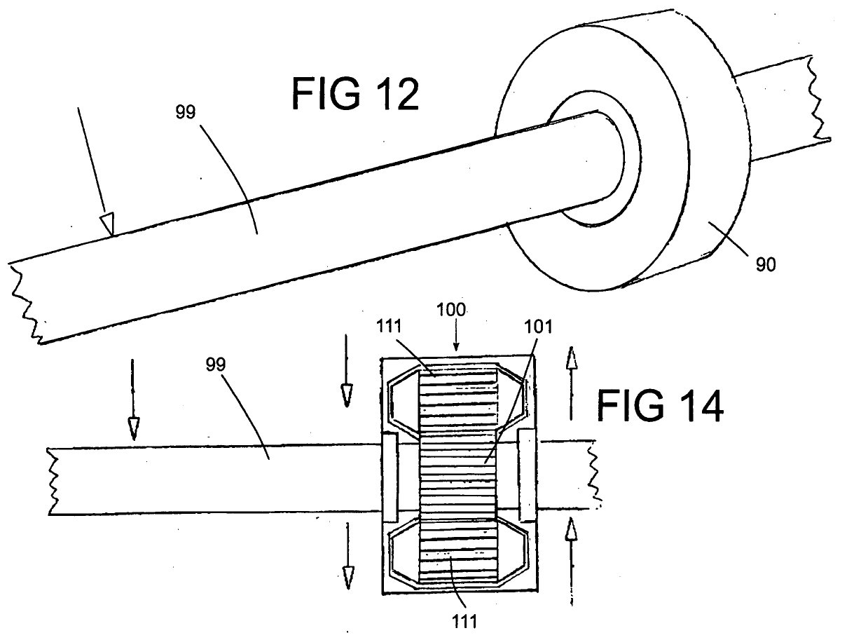

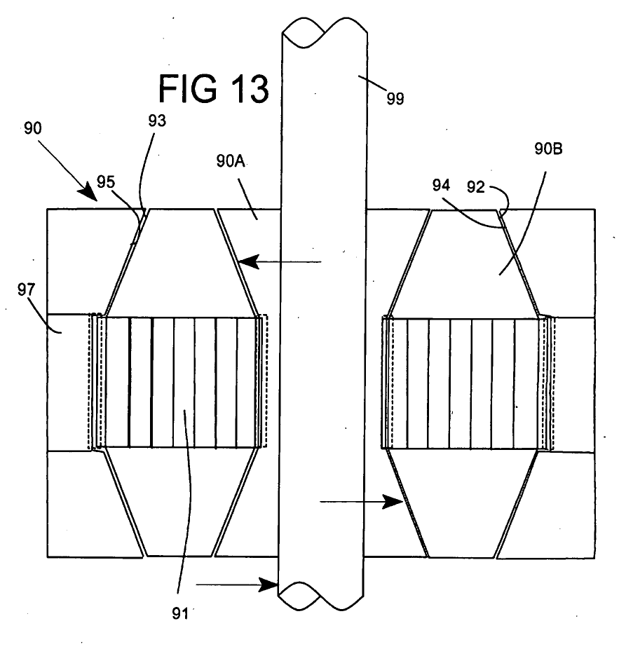

FIG. 12 is a view showing the application of one of the rotary gear bearing embodiments described herein to support a rotating shaft. Here gear bearing assembly 90 is employed with a rotating shaft 99. The side loads, which would be transmitted by this shaft to the gear bearing assembly 90, are represented by arrows. A more stable load bearing surface is maintained because the contact with the gear bearings will be a line contact, rather than only a point contact that would be established if ball bearings were employed. FIG. 13 shows a partial sectional view of one version of the gear bearing 90 that could be employed as the rotary or radial bearing in FIG. 12. The loads shown be arrows in FIG. 12 are shown as transmitted to the primary load bearing surfaces 92 and 93 of gear bearing 90A and 90B, which are two of the multiple gear bearings surrounding the shaft 99. Most of this load is transmitted to the primary load bearing surfaces 92 and 93 of gear bearings 90A and 90B by the tapered raceway surfaces 94 and 95, which are maintained in close proximity and are separated by a thin lubricating film. Gear bearing gears 91 mesh with gears 96 and 97 in the manner previously described with respect to the embodiments of FIGS. 4 and 5.

FIG. 14 is a view of another version of a gear bearing 100 that could be employed as in a gear bearing assembly used as a rotary or radial bearing for shaft 99 in FIG. 12. The difference between the gear bearing assembly shown in FIG. 14 and that shown in FIG. 13 is that the side loads are first transmitted through the gear teeth 111 on the gear bearing and then to tapered surfaces at the ends of these gear bearings. These tapered surfaces are inclined relative to those side loads and therefore the stresses or pressures should be smaller. The embodiment of FIG. 14 can be employed in situations when side loads will not damage the gears.

In addition to preventing bearings from gathering, the capability of the gear bearings to traverse a specified distance dependent upon the rotational velocity of the gear bearings makes it possible to use the gear bearings as position indicators. A magnet, transmitter or other detectable component may be mounted in the gear bearings. The hole left in the gear bearings during fabrication is especially suitable for positioning such a device. A dot or other indicia that can be optically sensed can also be employed. An external detector can be employed to detect the position of the transmitter or the detectable device mounted on the gear bearing. Since the gear bearings can be used in either linear or rotary gear bearing assemblies, it is possible to monitor the position of the gear bearing and to control linear and rotary motions of equipment such as transfer of items in an assembly line or in a warehouse. Gear bearings employed for such purposes can be termed smart gear bearings. It is also possible to employ the transmitter equipped gear bearings to determine the speed of rotation of a mechanism.

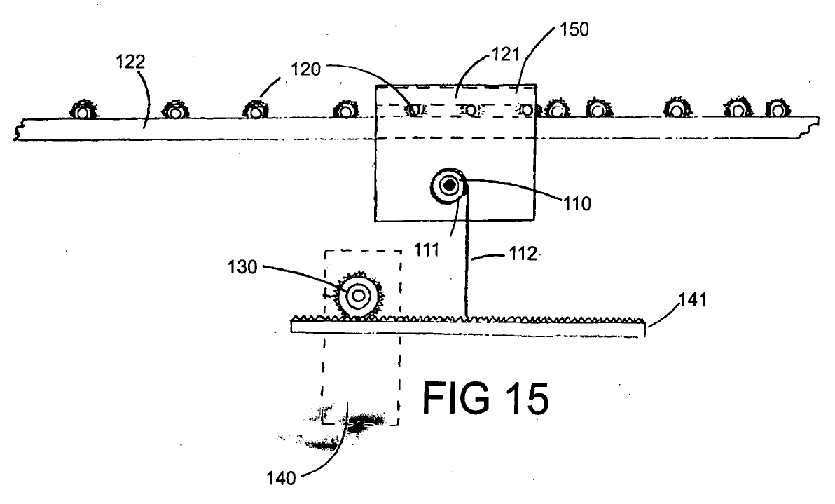

In one application as in FIG. 15, rotary bearings 110, 130 and linear bearings 120 can be used in a system, such as a warehouse or assembly line to pick up, deliver, transfer and manipulate using a transfer device 150. As raceway 121 moves along raceway 122, the raceway 111 will receive gear bearings 120 as it goes and it will return the gear bearings 120 to their original position as the raceway 121 returns from the opposite direction. Rotary bearings 110 are used with a pulley 111 to signal the pulley's drive mechanism to control how far cable 112 is to be discharged or retracted. Rotary gear bearing 130 is used to control the movement of pick up device 140 along gear track 141. Rotary gear bearings 110 and 130 can then be used to determine the relative vertical position of pick-up device 140 relative to the transfer device 150.

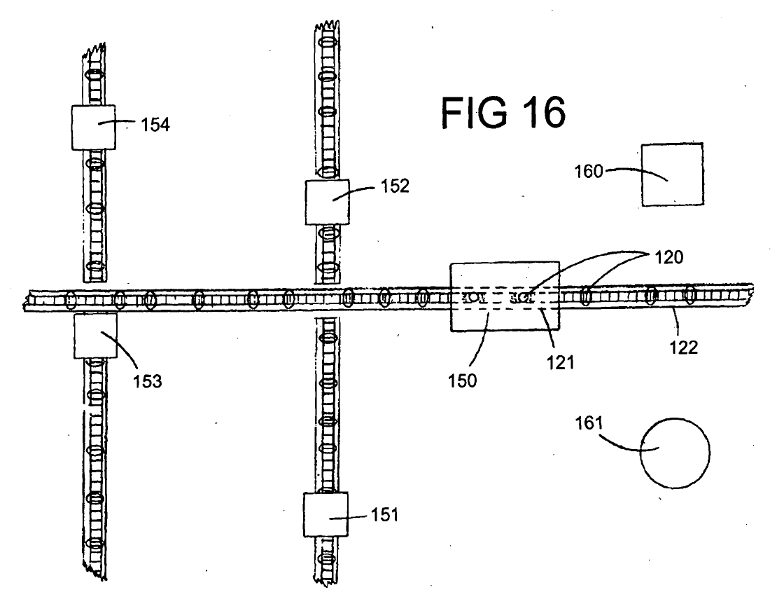

FIG. 16 demonstrates how rotary and linear gear bearings 110, 120 and 130 can be employed with the transfer mechanism such as in FIG. 15 in a warehouse or an assembly line situation. The gear bearing 110, 120 and 130 can comprise smart gear bearings including a transmitter or signaling device. Signals can be sent to the transfer device 150 to retrieve representative items 160 and 161, and deliver them to desired locations. Other transfer devices 151, 152, 153 and 154 can also deliver items to work stations, storage bins or aisles, parts distribution or other locations. The transmitting devices in the linear gear bearings 120 can be activated as the transfer devices pass so that a computer in communication with the smart linear gear bearings 120 can detect the position of the transfer devices. The linear smart gears 120 can include transmitters that are only activated when moved by the passage of a transfer device. Smart rotary gear bearings 110 and 130, also in communication with the computer, can then be used to monitor and control the movement of the pick up device 140 in each transfer device 150, 151, 152, 153 and 154. The smart gear bearings thus function as both a signaling mechanism and as an integral part the mechanical apparatus.

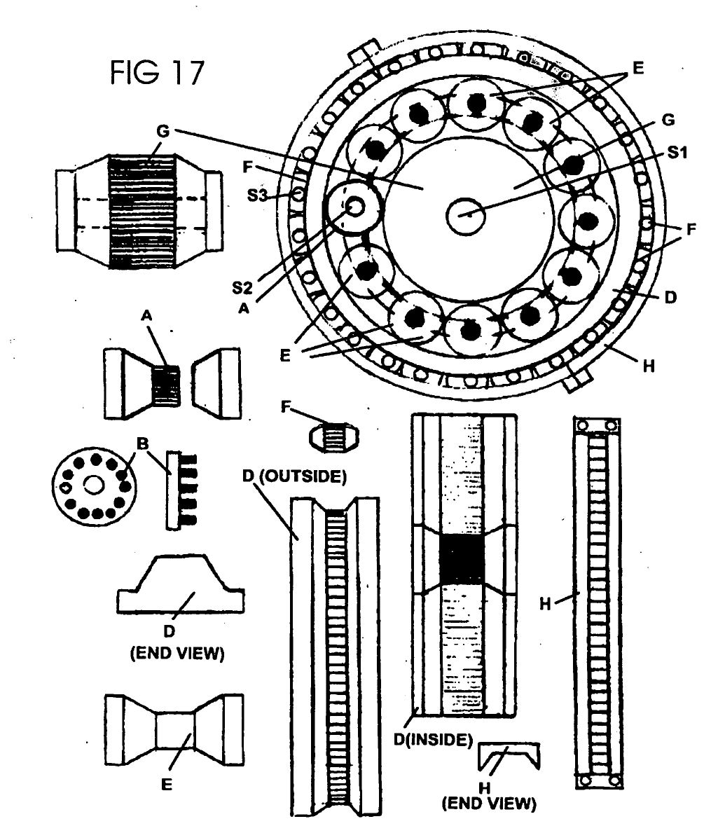

The embodiments of FIGS. 1-16 disclose a gear bearing that primarily functions as a bearing and does not transmit mechanical force. In other words the rotary gear bearings are not connected to shafts so that the gears bearings will not impart rotation to a driven shaft from a driving shaft. However, these gears, with their bearing surfaces, can be employed to transmit force if the rotary bearings are attached to shafts. The tapered bearing surfaces will function to bear end loads and laterally oriented loads so that separate bearings need not be incorporated onto a gearbox housing the bearing assembly. For instance, FIG. 17 shows a transmission employing gear bearings having tapered bearing surfaces in addition to the gear teeth. A central gear bearing G mounted on a driving shaft S1 has convex bearing surfaces flanking the gear teeth. A series of gear bearings A and E, each having concave tapered bearing surfaces are positioned around the central gear bearing G. Bearings E will function only as rotary bearings. However, one gear bearing A can be mounted on a shaft S2, so that rotation of shaft S1 can be transmitted to shaft S2. Gear bearings A and E can otherwise be identical, except that bearing E does not employ gear teeth. In this instance the rotational velocity of shaft S2 will be significantly greater than the rotational velocity of shaft S1. The gear bearing A and bearings E will each rotate about their axes, but the gear bearings A and E will not orbit the shaft S1 or the gear bearing G. A cage B will hold all of the bearings E, but not the gear bearing A attached to shaft S2 is place, while permitting the gear bearings to rotate. Each gear bearing A and E is a two piece assembly so that all of the gear bearings A and E can be mounted in a cylindrical track D, which can comprise a one-piece member. After a first part of each gear bearing A and E is assembled within track D, with teeth on the gear bearings A and E meshing with teeth on the interior of the cylindrical track D. The second part of bearings A and E, with a second bearing surface, will then be assembled to the first gearing bearing part, so that all of the gear bearings A and E will both mesh with track H. Track D has gears of different pitch on interior and exterior cylindrical surfaces, and includes tapered surfaces for engaging gear bearings on the interior and exterior of cylindrical gear track D. Another series of gear bearings F, with only one mounted to a shaft S3, is mounted on the exterior of the cylindrical track D. Gear bearings F, include convex tapered bearing surfaces flanking the gear teeth, and these gears F function substantially the same as gear bearings A and E. Rotational velocity of shaft S3, will however differ from the rotational velocity of shafts S1 and S2. An outer track H will be mounted on the exterior of the gear bearings F. Track H can be two pieces, and it will rotate relative to the gear bearings F.

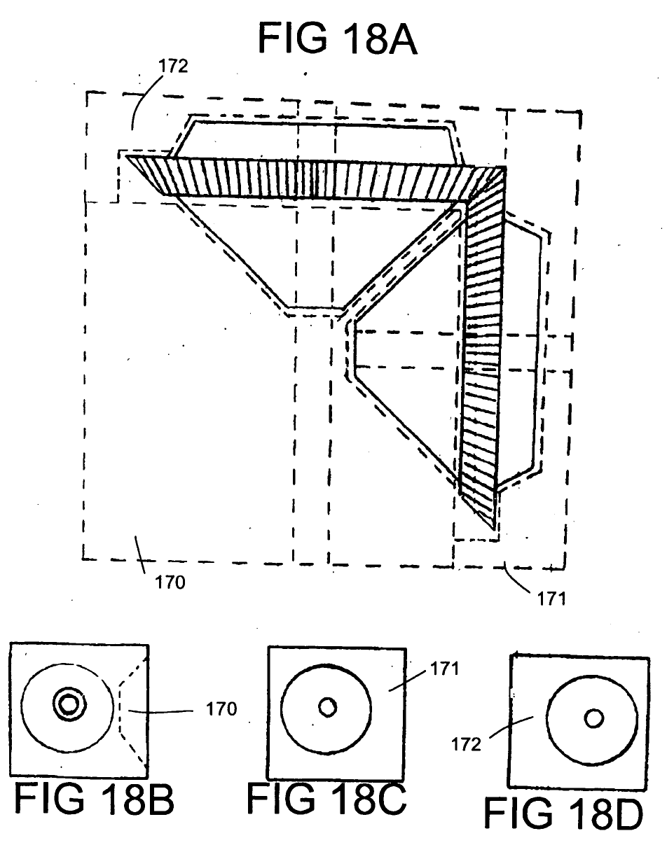

The same approach can be employed with bevel gears, as shown in FIGS. 18 A-D. These gears each include tapered surfaces which will be positioned in opposed relationship with tapered surfaces on external housings A, B and C so that lateral or end loads on the bears can be born by these bevel surfaces. Rotation of a horizontal shaft can then the imparted to a vertical shaft or vice versa.

I claim:

1. A bearing for supporting a first part moving relative to a first part in the presence of side loads acting between the two moving parts directed in either two directions perpendicular to a path defining the relative movement of the first and second moving parts, the bearing being suitable for use in either rotary bearing assemblies or guide bearing assemblies, the bearing comprising:
first and second tapered load bearing surfaces oriented such that contact lines formed along the first and second tapered load bearing surfaces intersect a plane parallel to the path of relative movement at an acute angle;
a radial gear extending between the first and second tapered load bearing surfaces, the first and second tapered load bearing surfaces extending away from the radial gear, the radial gear comprising means for imparting rotation to the bearing to reduce sliding engagement with the first and second load bearing surfaces when relative movement of the two moving parts is in either a linear path or a rotary path;
wherein the first tapered load bearing surface bears side loads in a first direction perpendicular to the path of relative movement and the second tapered load bearing surface bears side loads in a second direction, opposite the first direction.

2. The bearing of claim 1 wherein the first and second load bearing surfaces each taper toward a bearing axis of rotation at remote ends of the bearing.

3. The bearing of claim 1 wherein the first and second load bearing surfaces each taper toward a bearing axis of rotation adjacent the radial gear in the medial plane.

4. The bearing of claim 1 wherein the radial gear comprises a spur gear.

5. The bearing of claim 1 wherein the first and second tapered surfaces comprise conical surfaces.

6. The bearing of claim 5 wherein the conical surfaces are truncated at remote ends of the bearing.

7. The bearing of claim 1 wherein the gear bearing is machined from one piece of metal.

8. The bearing of claim 1 wherein the first and second tapered surfaces are formed on separate members that are attached together to form the bearing.

9. The bearing of claim 1 wherein the gearing is molded, with the first and second tapered surfaces comprising outwardly facing edges of tapered molded fins.

10. The bearing of claim 1 wherein the bearing comprises a rotary bearing.

11. The bearing of claim 1 wherein the bearing comprises a guide bearing.

12. The bearing of claim 1 wherein the bearing comprises a hydrostatic bearing.

13. The bearing of claim 1 wherein the bearing comprises a hydrodynamic bearing.

14. The bearing of claim 1 wherein the bearing comprises a thrust bearing.

15. The bearing of claim 1 wherein the load bearing tapered surfaces are configured relative to the gear so that most of the side load on the bearing are borne by the tapered surfaces.

16. A rotary bearing assembly comprising inner and outer circular raceways and a plurality of gear bearings disposed between the inner and outer circular raceways, the gear bearings and the inner and outer raceways having a common axis of rotation:
the inner and outer raceways each including at least one raceway tapered load bearing surface disposed at an angle relative to the common axis of rotation, at least one of the inner and outer raceways having a first gear profile with a gear axis aligned with the common axis of rotation;
each gear bearing including a second gear profile matable with the first gear profile on at least one of the raceways, and a gear bearing tapered surface opposed to one tapered load bearing surface of one of the inner and outer raceways, so that the gear profiles on the gear bearing and n at least one of the inner and outer raceways mesh while loads are borne by the tapered load bearing surfaces on the gear bearing and on at least one of the inner and outer raceways.

17. The gear bearing assembly of claim 16 wherein only one of the raceways includes a gear profile and the gear bearing rotates about its own axis while remaining at substantially the same position during mutual arcuate movement of the first raceway relative to the second raceway.

18. The gear bearing assembly of claim 16 wherein both of the raceways include a gear profile and the bearing orbits moves along a circular path also having the common axis of rotation.

19. The gear bearing assembly of claim 16 wherein each gear bearing has two gear bearing tapered surfaces oriented to act as thrust bearing surfaces and opposing two raceway tapered load bearing surfaces.

20. The gear bearing assembly of claim 19 wherein the gear profiles on both the gear bearing and the raceways are located between the two corresponding tapered load bearing surfaces.

21. The gear bearing assembly of claim 19 wherein the raceway and gear tapered load bearing surfaces comprise smooth conical surfaces.

22. A smart gear bearing for use in bearing loads between relatively moving components, the smart gear bearing comprising:
a bearing having primary load bearing surfaces;
a gear on the bearing comprising means for engaging a raceway to impart rotary motion to the bearing in response to relative movement of the relatively moving components; and
a remotely sensible device on the bearing, movement of the bearing being detected by a remote receiver so that the movement of the bearing can be detected.
